(19) United States
(12) Patent Application Publication
(10) Pub. No.: US 2024/0087807 A1
(43) Pub. Date: Mar. 14, 2024

(54) POWDER MAGNETIC CORE, INDUCTOR, AND METHOD FOR MANUFACTURING POWDER MAGNETIC CORE

(71) Applicant: TOKIN Corporation, Sendai-shi (JP)

(72) Inventors: Shun MIKOSHIBA, Sendai-shi (JP); Hiroshi SHIMA, Sendai-shi (JP); Kenichiro KOBAYASHI, Sendai-shi (DE); Akiri URATA, Sendai-shi (JP); Makoto YAMAKI, Sendai-shi (JP); Naoto ONISHI, Sendai-shi (JP)

(21) Appl. No.: 18/454,622

(22) Filed: Aug. 23, 2023

(30) Foreign Application Priority Data
Sep. 9, 2022 (JP) 2022-144031

(51) Int. Cl. H01F 41/02; H01F 1/26; H01F 3/08

(52) U.S. Cl. CPC H01F 41/0246; H01F 1/26; H01F 3/08; H01F 27/255

(57) ABSTRACT

A powder magnetic core according to an aspect of the present disclosure is a powder magnetic core in which a magnetic powder is bonded via a binder layer. The powder magnetic core contains 88 volume % or more of magnetic powder, and when a cross-sectional photograph of the powder magnetic core is taken, an area of the cross-sectional photograph having a size of 10000 μm² is divided into unit areas, one or more of the unit areas in which the size of a cross-sectional area of a binder accounts for 50% or more of the unit area are extracted as specific unit areas, and the percentage of the number of specific unit areas with respect to the total number of unit areas is equal to or larger than 0.2% but equal to or smaller than 3.0%.

### INCORPORATION BY REFERENCE

This application is based upon and claims the benefit of priority from Japanese patent application No. 2022-144031, filed on Sep. 9, 2022, the disclosure of which is incorporated herein in its entirety by reference.

### BACKGROUND

The present disclosure relates to a powder magnetic core, an inductor, and a method for manufacturing a powder magnetic core.

In recent years, inductors have been used in a variety of electronic devices. Inductors used in electronic devices such as personal computers, in particular, are required to be small in size and to exhibit high inductance characteristics even when a large current is made to flow through the inductors. Japanese Unexamined Patent Application Publication No. H10-212503 discloses a method for manufacturing a pressed powder body of amorphous magnetically soft alloy having less diminished in magnetic permeability in a high frequency range.

### SUMMARY

As described above, it is required that inductors have a small size and exhibit high inductance characteristics even when a large current is made to flow through the inductors. In particular, since inductors that are used in electronic devices such as personal computers are used in a high frequency range (e.g., 750 kHz-2 MHz), an inductor having a low loss in a high frequency range is required.

In view of the aforementioned problem, the present disclosure aims to provide a powder magnetic core, an inductor, and a method for manufacturing a powder magnetic core capable of achieving a low loss in a high frequency range while reducing the respective sizes of the powder magnetic core and the inductor.

A powder magnetic core according to one aspect of the present disclosure is a powder magnetic core in which a magnetic powder is bonded via a binder layer. The powder magnetic core contains 88 volume % or more of magnetic powder, and when a cross-sectional photograph of the powder magnetic core is taken using a scanning electron microscope, an area of the cross-sectional photograph having a size of 10000 μm² is divided into unit areas, each unit area having a square having a size of 0.5 μm×0.5 μm, one or more of the unit areas in which the size of a cross-sectional area of a binder accounts for 50% or more of the unit area are extracted as specific unit areas, and the percentage of the number of specific unit areas that have been extracted with respect to the total number of unit areas is defined to be a percentage of the area occupied by the binder, the percentage of the area occupied by the binder is equal to or larger than 0.2% but equal to or smaller than 3.0%.

An inductor according to one aspect of the present disclosure includes the aforementioned powder magnetic core and a coil.

A method for manufacturing a powder magnetic core according to one aspect of the present disclosure includes: a process of coating a magnetic powder with a low melting glass; a process of coating the magnetic powder coated with the low melting glass with a resin material for granulation; and a process of hot forming the magnetic powder after the granulation. The powder magnetic core after the hot forming contains 88 volume % or more of magnetic powder, and when a cross-sectional photograph of the powder magnetic core is taken using a scanning electron microscope, an area of the cross-sectional photograph having a size of 10000 μm² is divided into unit areas, each unit area having a square having a size of 0.5 μm×0.5 μm, one or more of the unit areas in which the size of a cross-sectional area of a binder accounts for 50% or more of the unit area are extracted as specific unit areas, and the percentage of the number of specific unit areas that have been extracted with respect to the total number of unit areas is defined to be a percentage of the area occupied by the binder, the percentage of the area occupied by the binder is equal to or larger than 0.2% but equal to or smaller than 3.0%.

According to the present disclosure, it is possible to provide a powder magnetic core, an inductor, and a method for manufacturing a powder magnetic core capable of achieving a low loss in a high frequency range while reducing the respective sizes of the powder magnetic core and the inductor.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing one example of an inductor according to an embodiment;

FIG. 2 shows electron micrographs of a powder magnetic core according to related art and a powder magnetic core according to the present disclosure;

FIG. 3 is a schematic view showing a microstructure of the powder magnetic core according to related art and a powder magnetic core according to the present disclosure;

FIG. 4 is a diagram for describing how to obtain the percentage of an area occupied by a binder;

FIG. 5 is a diagram for describing how to obtain the percentage of the area occupied by the binder;

FIG. 6 is a diagram for describing how to obtain the percentage of the area occupied by the binder;

FIG. 7 is a flowchart for describing a method for manufacturing the powder magnetic core according to the embodiment;

FIG. 8 is a schematic view for describing a method for manufacturing the powder magnetic core according to the embodiment;

FIG. 9 is a horizontal cross-sectional view of the powder magnetic core according to the embodiment;

FIG. 10 is a horizontal cross-sectional view of the powder magnetic core according to the embodiment;

FIG. 11 is a horizontal cross-sectional view of the powder magnetic core according to the embodiment;

FIG. 12 is a horizontal cross-sectional view of the powder magnetic core according to the embodiment;

FIG. 13 is a graph showing a relation between the percentage of the area occupied by the binder and an iron loss; and

FIG. 14 is a graph showing a relation between the percentage of the area occupied by the binder and a specific resistance.

### DESCRIPTION OF EMBODIMENTS

### <Inductor>

Hereinafter, with reference to the drawings, the present disclosure will be described.

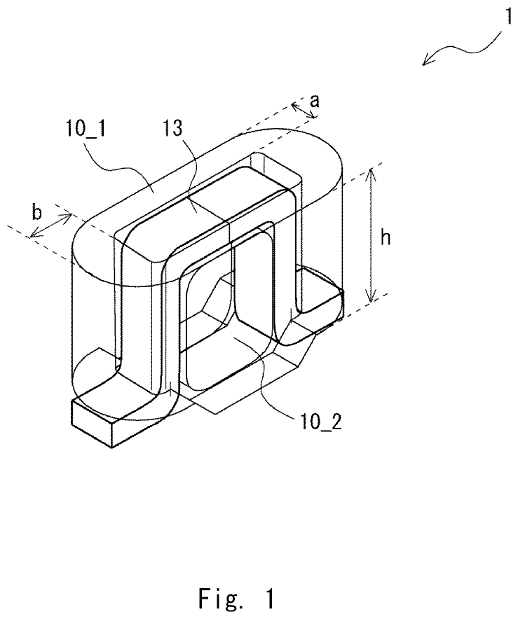

FIG. 1 is a perspective view showing one example of an inductor according to this embodiment. As shown in FIG. 1, an inductor 1 according to this embodiment includes powder magnetic cores 10_1 and 10_2, and a coil 13. The powder magnetic core 10_1, which includes a cavity penetrating the center thereof in the vertical direction, is disposed so as to surround the outer side of the coil 13. The powder magnetic core 10_2, which is provided inside the coil 13, is disposed in a recessed part of the coil 13 having a U-shaped cross section.

For example, the inductor 1 shown in FIG. 1 is formed by arranging the powder magnetic core 10_2 in the recessed part of the coil 13 and press-fitting the powder magnetic core 10_1 from above. Accordingly, the inductor 1 including the coil 13 surrounded by the powder magnetic cores 10_1 and 10_2 can be formed. The powder magnetic cores 10_1 and 10_2 may also be collectively referred to as a powder magnetic core 10 in this description. Further, the structure of the inductor 1 shown in FIG. 1 is merely one example and the powder magnetic core 10 according to this embodiment may be used for an inductor including a structure other than that shown in FIG. 1. The powder magnetic core according to this embodiment achieves a low loss in a high frequency range while the size thereof is reduced. Hereinafter, the powder magnetic core according to this embodiment will be described in detail.

### <Powder Magnetic Core>

The powder magnetic core according to this embodiment is a powder magnetic core in which a magnetic powder is bonded via a binder layer. The powder magnetic core contains 88 volume % or more of magnetic powder. Further, when a cross-sectional photograph of the powder magnetic core is taken using a scanning electron microscope, an area of the cross-sectional photograph having a size of 10000 μm² is divided into unit areas (i.e., subareas), each unit area having a square having a size of 0.5 μm×0.5 μm, one or more of the unit areas in which the size of a cross-sectional area of a binder accounts for 50% or more of the unit area are extracted as specific unit areas, and the percentage of the number of specific unit areas that have been extracted with respect to the total number of unit areas is defined to be a percentage of the area occupied by the binder, the percentage of the area occupied by the binder is equal to or larger than 0.2% but equal to or smaller than 3.0%. With the above structure, it is possible to provide a powder magnetic core capable of achieving a low loss in a high frequency range while reducing the size thereof. In this embodiment, the aforementioned percentage of the area occupied by the binder may be equal to or larger than 0.2% but equal to or smaller than 2.6%.

The magnetic powder used for the powder magnetic core according to this embodiment is a soft magnetic powder containing an iron element. For example, the particle size of the magnetic powder is equal to or larger than 2 μm but equal to or smaller than 25 μm, preferably equal to or larger than 5 μm but equal to or smaller than 15 μm. In the present disclosure, the particle size is a median diameter D50. This is a value measured by using a laser diffraction-scattering method.

In this embodiment, a metallic glass may be used as the magnetic powder. The metallic glass may be, for example, an amorphous metallic glass prepared by an atomizing method. It may be, for example, an Fe—P—B alloy, an Fe—B—P—Nb—Cr alloy, an Fe—Si—B alloy, an Fe—Si—B—P alloy, an Fe—Si—B—P—Cr alloy, or an Fe—Si—B—P—C alloy. By powdering them by an atomizing method, the metallic glass having a glass transition point can be formed. In the present disclosure, in particular, an Fe—B—P—Nb—Cr-based material is preferably used. The metallic glass obtained by the atomizing method is not limited thereto and may be a metallic glass that does not have a glass transition point.

Further, in this embodiment, a nanocrystallized powder may be, for example, used as the magnetic powder. For example, the nanocrystallized powder may be the one prepared by an atomizing method. For example, by powdering an Fe—Si—B—P—C—Cu-based material, an Fe—Si—B—Cu—Cr-based material, an Fe—Si—B—P—Cu—Cr-based material, an Fe—B—P—C—Cu-based material, an Fe—Si—B—P—Cu-based material, an Fe—B—P—Cu-based material, or an Fe—Si—B—Nb—Cu-based material by using the atomizing method, a nanocrystallized powder including at least two exothermic peaks indicating crystallization in the heat treatment process of the magnetic powder can be formed. The nanocrystallized powder to be used, which is not particularly limited, may preferably be, for example, an Fe—Si—B—P—Cu—Cr-based material.

In this embodiment, the closer the shape of particles of the magnetic powder is to spherical, the better. When the sphericity of the particles is low, protrusions are formed on the surface of the particles. When a molding pressure is applied, stress from surrounding particles concentrates on the protrusions, causing the coating to break and a sufficiently high insulation cannot be maintained, which may result in deterioration of the magnetic properties (in particular, loss) of the resulting powder magnetic core. The sphericity of the particles may be controlled within a suitable range by adjusting manufacturing conditions of the magnetic powder such as a water volume and a water pressure of high-pressure water jet used for atomization if a water atomizing method is employed, the temperature and the supply rate of a molten material. The specific manufacturing conditions vary depending on the composition of the magnetic powder to be manufactured or the desired productivity.

In the powder magnetic core according to this embodiment, the binder layer includes a function of binding particles of the magnetic powder. The binder layer includes a low melting glass and a resin material. In this embodiment, the total amount of the low melting glass and the resin material is less than 10 volume % with respect to the amount of the magnetic powder of the powder magnetic core. The low melting glass may be a phosphate-based glass, a tin phosphate-based glass, a borate-based glass, a silicate-based glass, a boro-silicate-based glass, a bariumsilicate-based glass, a bismuth oxide-based glass, a germanate-based glass, a vanadate-based glass, an aluminophosphate-based glass, an arsenate-based glass, a telluride-based glass or the like. In particular, in the present disclosure, a phosphate-based or a tin phosphate-based low melting glass is preferably used. Further, the volume percentage of the low melting glass with respect to the volume of the magnetic powder is equal to or larger than 0.5 volume % but equal to or smaller than 6 volume %, preferably equal to or larger than 1.25 volume % but equal to or smaller than 3 volume %.

Further, the resin material included in the binder layer may be at least one type of resin material selected from the group consisting of a phenol resin, a polyimide resin, an epoxy resin, and an acrylic resin. Further, the volume percentage of the resin material with respect to the volume of magnetic powder is equal to or larger than 0.5 volume % but equal to or smaller than 9 volume %, preferably equal to or larger than 1 volume % but equal to or smaller than 5 volume %.

Further, in the powder magnetic core according to this embodiment, when a cross-sectional photograph of the powder magnetic core is taken using a scanning electron microscope, an area of the cross-sectional photograph having a size of 10000 μm² is divided into unit areas, each unit area having a square having a size of 0.5 μm×0.5 μm, one or more of the unit areas in which the size of a cross-sectional area of a binder accounts for 50% or more of the unit area are extracted as specific unit areas, and the percentage of the number of specific unit areas that have been extracted with respect to the total number of unit areas is defined to be a percentage of the area occupied by the binder, the percentage of the area occupied by the binder is equal to or larger than 0.2% but equal to or smaller than 3.0%. Since the powder magnetic core according to this embodiment has the aforementioned configuration, it becomes possible to maintain a sufficiently high insulation between particles of the magnetic powder while decreasing the volume percentage of the binder layer and thus increasing the filling percentage of the magnetic powder. Accordingly, with the powder magnetic core according to this embodiment, it is possible to reduce the loss in the inductor in a high frequency range while reducing the size thereof.

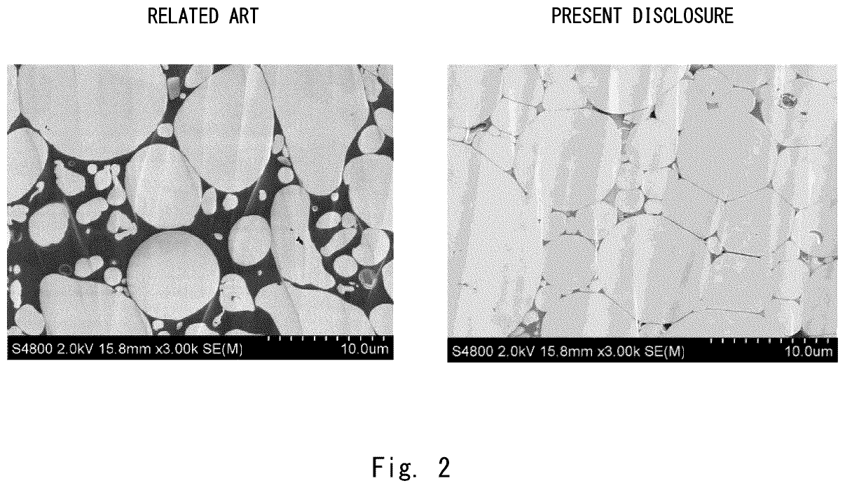

FIG. 2 shows electron micrographs of a powder magnetic core according to related art and the powder magnetic core according to the present disclosure. In the related art shown in FIG. 2, the filling percentage of the magnetic powder is low. On the other hand, the filling percentage of the magnetic powder of the powder magnetic core according to the present disclosure is higher than the filling percentage of the magnetic powder of the powder magnetic core according to related art. Therefore, even when a large current is made to flow through the inductor, the inductor exhibits high inductance characteristics.

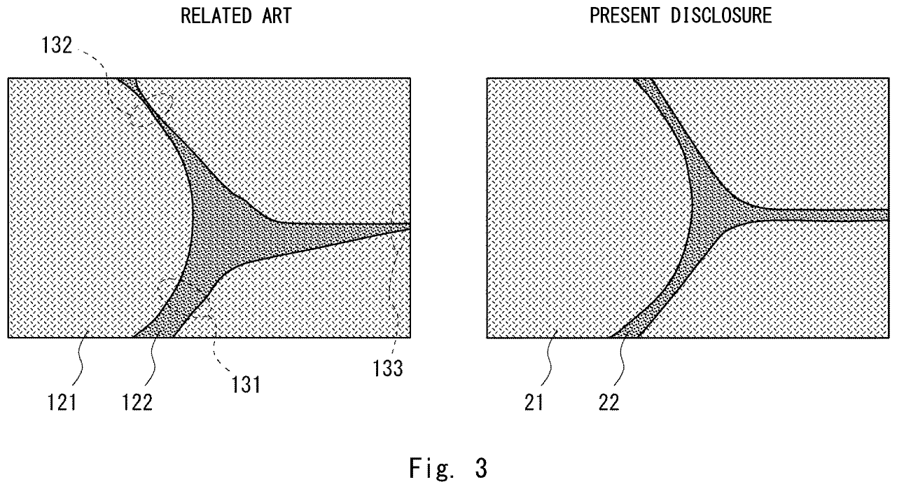

FIG. 3 is a schematic view showing a microstructure of the powder magnetic core according to related art and a microstructure of the powder magnetic core according to the present disclosure. In the related art shown in FIG. 3, the thickness of a binder layer 122 that is present between particles of a magnetic powder 121 is uneven. For example, while the thickness of the binder layer 122 is large in an area 131, the thickness of the binder layer 122 is small in areas 132 and 133. That is, in this case, the percentage of the specific unit area where the size of the cross-sectional area of the binder accounts for 50% or more of the area in the binder layer 122 that is present between particles of the magnetic powder 121 (i.e., the percentage of the area in the binder layer 122 such as the area 131 where the thickness of the binder layer 122 is large) is high. Therefore, as a result, the percentage of the area in the binder layer 122 like the areas 132 and 133 where the thickness of the binder layer 122 is small and a sufficiently high insulation between particles of the magnetic powder cannot be maintained becomes high.

On the other hand, in the powder magnetic core according to the present disclosure, the thickness of a binder layer 22 that is present between particles of a magnetic powder 21 is even. That is, the percentage of the specific unit area where the size of the cross-sectional area of the binder accounts for 50% or more (i.e., the percentage the area in the binder layer 22 where the binder layer 22 is thick) of the unit area in the binder layer 22 that is present between particles of the magnetic powder 21 is small. Therefore, as a result, the percentage of the area in the binder layer 22 where the binder layer 22 is thin becomes small, the entire binder layer 22 becomes even, and as a result it becomes possible to maintain a sufficiently high insulation between particles of the magnetic powder. As one example, the median thickness of the binder layer 22 of the powder magnetic core according to the present disclosure is equal to or smaller than 0.2 μm.

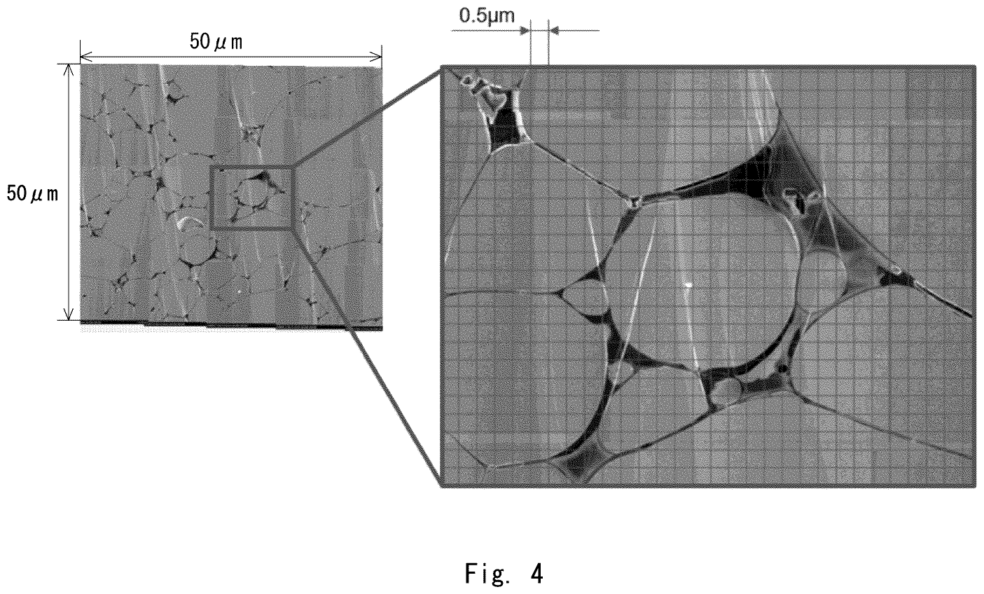

FIGS. 4 to 6 are diagrams for describing how to obtain the percentage of the area occupied by the binder. In this embodiment, the percentage of the area occupied by the binder is obtained using the following method.

First, as shown in FIG. 4, a cross-section sample of a powder magnetic core is prepared by a method such as an ion milling method that has little effect on the cross-section microstructure, and a cross-sectional photograph of the powder magnetic core is taken using a scanning electron microscope (SEM). At this time, a cross-sectional photograph of the center of the powder magnetic core is taken. For example, a cross-sectional photograph of an area having a size of 50 μm×50 μm (2500 μm²) is taken.

Next, as shown in FIG. 4, the area of the cross-sectional photograph (50 μm×50 μm) that has been taken is divided into unit areas, each unit area having a square having a size of 0.5 μm×0.5 μm. In other words, the lateral direction of the cross-sectional photograph (50 μm) is divided by lines having intervals of 0.5 μm between them. Further, the vertical direction of the cross-sectional photograph (50 μm) is divided by lines having intervals of 0.5 μm between them. By dividing the cross-sectional photograph of 50 μm×50 μm by a unit area of a square having a size of 0.5 μm×0.5 μm, the cross-sectional photograph can be divided into 10000 unit areas.

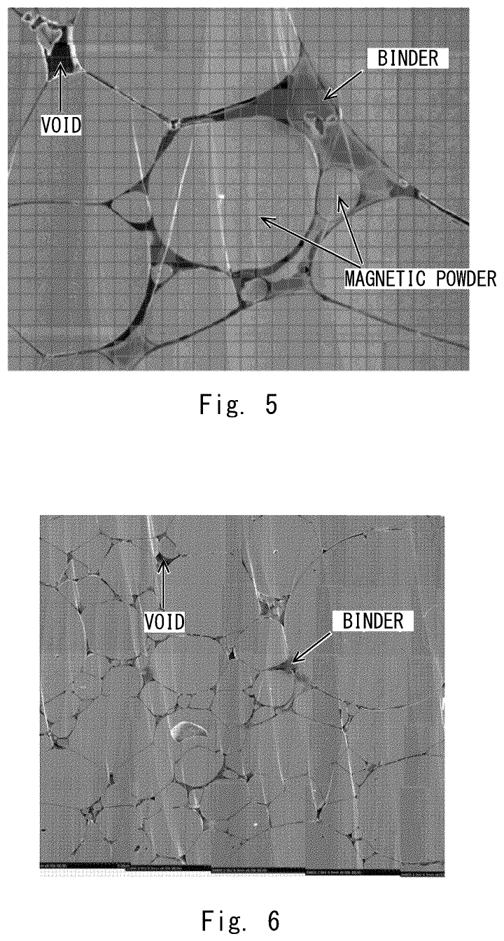

Next, as shown in FIG. 5, one or more of the unit areas that have been divided in which the size of the cross-sectional area of the binder accounts for 50% or more of the unit area are extracted as specific unit areas. Note that the binder, the magnetic powder, and voids can be distinguished from one another by using the contrast of an SEM image, edge effects, etc. Further, any binder is determined to be a binder regardless of whether it is an inorganic binder (a low melting glass) or an organic binder (a resin material). Further, the percentage of the area of the binder to each unit area may be determined using an image analysis software.

Next, the percentage of the number of specific unit areas that have been extracted with respect to the total number of unit areas is obtained as a percentage of the area occupied by the binder. Specifically, the percentage of the area occupied by the binder is obtained by the following expression.

Percentage of the area occupied by the binder=(number of specific unit areas that have been extracted/total number of unit areas)×100(%)

In the examples shown in FIGS. 5 and 6, since the total number of unit areas is 10000 and the number of specific unit areas that have been extracted is 197, the percentage of the area occupied by the binder is (197/10000)×100=1.97%.

In this embodiment, the total size of the cross-sectional photographs to be taken is set to be 10000 μm². For example, four cross-sectional photographs, each having a size of 50 μm×50 μm (2500 μm²), are taken, and the percentage of the area occupied by a binder is obtained for each of the cross-sectional photographs, the average value of the obtained values being determined to be the percentage of the area occupied by the binder. In another example, a cross-sectional photograph having a size of 100 μm×100 μm (10000 μm²) may be taken, this cross-sectional photograph may be divided into unit areas, each unit area having a square having a size of 0.5 μm×0.5 μm, and as a result the percentage of the area occupied by the binder may be obtained.

In this embodiment, the aforementioned percentage of the area occupied by the binder is equal to or larger than 0.2% but equal to or smaller than 3.0%, preferably equal to or larger than 0.2% but equal to or smaller than 2.6%, preferably equal to or larger than 0.2% but equal to or smaller than 2.4%, preferably equal to or larger than 0.5% but equal to or smaller than 1.8%, preferably equal to or larger than 0.5% but equal to or smaller than 1.1%, and preferably equal to or larger than 0.5% but equal to or smaller than 0.8%.

In this embodiment, the iron loss of the powder magnetic core at 1 MHz and 50 mT is equal to or smaller than 3300 kW/m³, preferably equal to or smaller than 2500 kW/m³, more preferably equal to or smaller than 2000 kW/m³, further preferably equal to or smaller than 1500 kW/m³, and most preferably equal to or smaller than 1000 kW/m³.

In this embodiment, the specific resistance of the powder magnetic core is equal to or larger than 5×10⁴ (Ωm), preferably equal to or larger than 1×10⁵ (Ωm), and further preferably equal to or larger than 1×10⁶ (Ωm).

### <Method for Manufacturing Powder Magnetic Core>

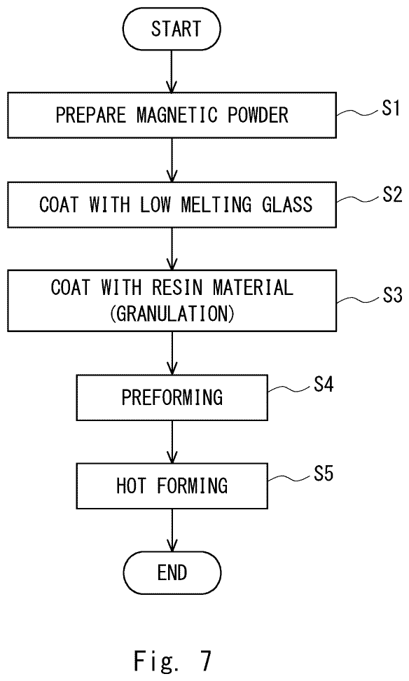

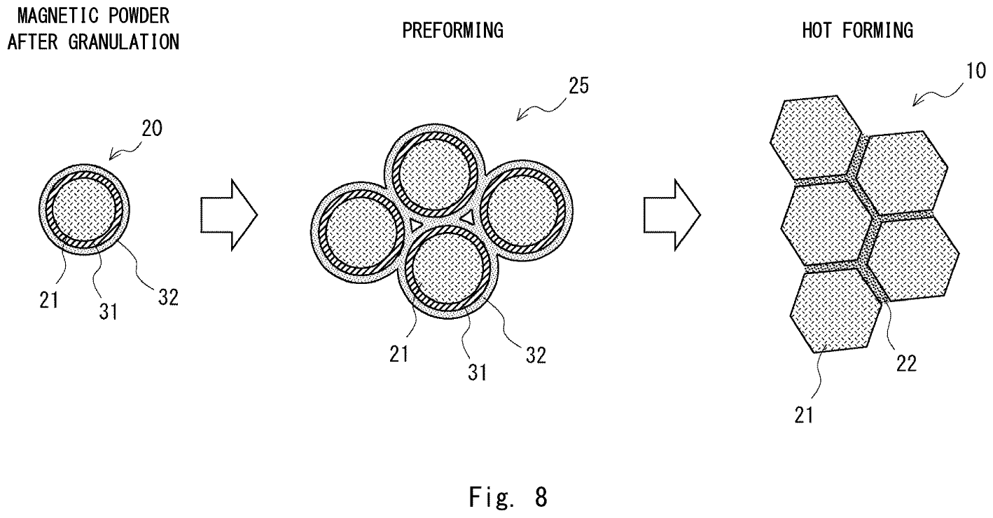

Next, a method for manufacturing the powder magnetic core according to this embodiment will be described. FIG. 7 is a flowchart for describing the method for manufacturing the powder magnetic core according to this embodiment. FIG. 8 is a schematic view for describing the method for manufacturing the powder magnetic core according to this embodiment.

As shown in FIG. 7, when the powder magnetic core is prepared, the magnetic powder is prepared first (Step S1). The magnetic powder may be the aforementioned magnetic powder. The magnetic powder is preferably made of a magnetic material that is softened at 400° C. or higher (a material that is easily deformed during hot forming). For example, by vacuum melting raw materials of the magnetic powder and then performing powderization and quenching concurrently using a water atomizing method, an amorphous magnetic powder can be obtained. The magnetic powder thus obtained may be classified as needed to remove abnormally coarsened powder.

Next, the magnetic powder is coated with a low melting glass (Step S2). The low melting glass is preferably made of a material that is softened at 400° C. or higher, that is, a material that is softened at high temperatures and serves as an insulation material and a bonding material after hot forming. The low melting glass may be, for example, a phosphate-based glass. When the magnetic powder is coated with the low melting glass, a wet thin-film formation method such as a sol-gel method, or a dry thin-film formation method such as a mechanochemical method or sputtering may be used. For example, according to the mechanochemical method, a layer of the low melting glass can be formed on the surface of the magnetic powder by mixing the magnetic powder with the low melting glass powder while applying a strong mechanical energy.

As one example, 1000 g of magnetic powder is mixed with 10 g of low melting glass powder, and the magnetic powder is coated with the low melting glass using a mechanochemical method. Accordingly, the volume percentage of the low melting glass that coats the magnetic powder with respect to the volume of the magnetic powder may be made equal to or larger than 0.5 volume % but equal to or smaller than 6 volume %.

Next, the magnetic powder coated with the low melting glass is coated with the resin material for granulation (Step S3). This resin material may be the aforementioned resin material. The resin material is preferably made of a material that is softened at about 100° C. and serves as an insulation material and a bonding material after hot forming. Further, the resin material is preferably a material that is not likely to be decomposed during hot forming (at a high temperature). When the magnetic powder is coated with the resin material (granulated), a rolling granulation method, a spray-dry method or the like may be used. Specifically, by mixing the resin material dissolved in an organic solvent with the magnetic powder coated with the low melting glass and drying the resulting object, a resin layer can be formed on the low melting glass of the magnetic powder.

FIG. 8 shows, in the left diagram, a magnetic powder after granulation 20. As shown in FIG. 8, in the magnetic powder after granulation 20, a magnetic powder 21 is coated with a low melting glass 31, and further the low melting glass 31 is coated with a resin material 32. As one example, the diameter of the magnetic powder 21 is 9 μm, the thickness of the low melting glass 31 is 20 nm, and the thickness of the resin material 32 is 20 nm.

Next, the magnetic powder after granulation is preformed (Step S4).

For example, preforming can be conducted by putting the magnetic powder after granulation into a die for pressurization (e.g., 500 kgf/cm² at room temperature), and heating the pressed powder body (i.e., green compact) to a predetermined temperature (e.g., 100° C.-150° C.) and curing the pressed powder body without pressurization. When the resin material that is used is a thermosetting resin, the intermediate formed body is formed using curing of resin during heating. When the resin material that is used is a thermoplastic resin, the intermediate formed body is formed by softening of the resin during heating and solidification during cooling.

That is, as shown in the central diagram of FIG. 8, when the magnetic powder after granulation is preformed, the particles of the magnetic powder 21 (coated with the low melting glass 31) are bonded to one another via the outermost resin material 32 and an intermediate formed body 25 is formed. Since the low melting glass is not softened at the preforming temperature (e.g., 150° C.), it does not exhibit bonding and flow properties. Note that the preforming process (Step S4) may be omitted.

Next, the intermediate formed body after preforming (when Step S4 is omitted, magnetic powder after granulation) is subject to hot forming (Step S5). The hot forming is conducted by applying pressure while heating the intermediate formed body that has been preformed (or the magnetic powder after granulation) in a state in which it is put into the die heated in advance. For example, the heating temperature at this time is set as follows.

When the magnetic powder that has been used is a metallic glass, the temperature when the magnetic powder is subject to hot forming is set to a temperature equal to or higher than one of a softening temperature of the low melting glass and a glass transition temperature of the magnetic powder which is higher than the other one, but is equal to or lower than a crystallization temperature of the magnetic powder. By setting the hot forming temperature to a temperature equal to or higher than the softening temperature of the low melting glass, the low melting glass is likely to be deformed in association with the plastic deformation of the magnetic powder, whereby it is possible to ensure insulation between particles of the magnetic powder. By setting the hot forming temperature to a temperature equal to or higher than the glass transition temperature of the magnetic powder, plastic deformation of the magnetic powder is more likely to occur, whereby a high filling percentage of the magnetic powder can be obtained. As one example, the hot forming temperature is equal to or higher than 450° C. but equal to or lower than 500° C.

When the magnetic powder that has been used is a nanocrystallized powder, the temperature when the magnetic powder is subject to hot forming is set to a temperature equal to or higher than one of a softening temperature of the low melting glass and a first crystallization temperature of the magnetic powder which is higher than the other one but is equal to or lower than a second crystallization temperature of the magnetic powder. By setting the hot forming temperature to a temperature equal to or higher than the softening temperature of the low melting glass, the low melting glass is likely to be deformed in association with the plastic deformation of the magnetic powder, whereby it is possible to ensure insulation between particles of the magnetic powder. By setting the hot forming temperature to a temperature around the first crystallization temperature, an α-Fe phase is crystallized, and at the same time plastic deformation of the magnetic powder becomes more likely to occur, whereby a high filling percentage of the magnetic powder can be obtained. Further, by setting the hot forming temperature to be a temperature equal to or lower than the second crystallization temperature, it is possible to prevent deterioration of magnetic properties, which is due to crystallization of a large amount of a compound phase such as a boride. As one example, the hot forming temperature is set to be a temperature equal to or higher than 400° C. but equal to or lower than 500° C. Further, in the present disclosure, the hot forming temperature is preferably equal to or higher than one of the softening temperature of the low melting glass and the first crystallization temperature of the magnetic powder +40° C. which is higher than the other one. The first crystallization temperature and the second crystallization temperature are defined as follows. That is, heat treatment of the magnetic material having an amorphous structure causes crystallization to occur more than once. The temperature at which crystallization starts first is the first crystallization temperature and the temperature at which crystallization then starts is the second crystallization temperature. More specifically, the magnetic powder includes at least two exothermic peaks that exhibit crystallization in the heating process of a DSC curve obtained by differential scanning calorimetry (DSC). Of the exothermic peaks, the exothermic peak on the lowest temperature side indicates the first crystallization temperature at which an α-Fe phase is crystallized, and the next exothermic peak indicates the second crystallization temperature at which a compound phase such as a boride or the like is crystallized.

In this embodiment, the heating temperature is preferably set to a temperature in the aforementioned temperature range and temperature conditions are preferably such that the value of the iron loss of the powder magnetic core becomes small.

Further, in this embodiment, the heating rate during hot forming may be set to 133° C./min or higher, preferably 1000° C./min or higher, and more preferably 2000° C./min or higher. If the heating rate is too slow, thermal decomposition of the resin material used for the binder layer advances, whereby the effect of suppressing the flow properties of the low melting glass is reduced and the iron loss of the powder magnetic core becomes large.

In this embodiment, the heating rate is as follows.

When preforming (Step S4) is performed heating rate=(hot forming temperature−temperature of intermediate formed body)/hot forming time (1)

When preforming (Step S4) is omitted heating rate=(hot forming temperature−temperature of magnetic powder after granulation)/hot forming time (2)

Further, the pressure when hot forming is performed is, for example, 5-10 ton·f/cm². If the pressure is too low, the filling percentage of the formed body (powder magnetic core) becomes low and the iron loss of the powder magnetic core becomes large. On the other hand, if the pressure is too high, the die is severely worn, which is not desirable in terms of cost. Therefore, the pressure is preferably set to a pressure in the aforementioned range.

Further, the hot forming is preferably performed within a range of 5-90 seconds, and more preferably, equal to or shorter than 30 seconds. If the forming time is too short, heat does not sufficiently reach the inside of the formed body and a sufficient amount of deformation due to softening of the magnetic powder cannot be obtained, whereby the filling percentage of the formed body becomes low and the iron loss of the powder magnetic core becomes large. On the other hand, if the forming time is too long, thermal decomposition of the resin material used for the binder layer advances, whereby the effect of suppressing the flow properties of the low melting glass is reduced and the iron loss of the powder magnetic core becomes large. Therefore, the hot forming time may be set within a range in which heat is sufficiently transferred to the interior of the formed body, deformation due to softening of the magnetic powder is completed, thermal decomposition of the resin material used for the binder layer does not advance, and the cost is not high. The forming time is preferably set to a time within the aforementioned range.

As one example, hot forming may be performed at a hot forming temperature: 480° C., at a hot forming pressure: 8 ton·f/cm², and for a hot forming time: 10 seconds.

In this embodiment, hot forming may be performed in the air atmosphere. In this case, magnetic powder that is in contact with the die before being filled highly, that is, only the surface of the powder magnetic core is oxidized. Therefore, the specific resistance on the surface of the powder magnetic core increases, which causes the frequency characteristics to be improved and the iron loss in a high frequency range (e.g., 1 MHz) is reduced.

As shown in the right view of FIG. 8, in the formed body (powder magnetic core) 10 after the hot forming, the particles of the magnetic powder 21 are bonded to one another via the binder layer 22 including a low melting glass and a resin material. In this embodiment, the volume percentage of the particles of the magnetic powder contained in the powder magnetic core 10 is set to be 88 volume % or higher. Further, when a cross-sectional photograph of the powder magnetic core is taken using a scanning electron microscope, an area of the cross-sectional photograph having a size of 10000 μm² is divided into unit areas, each unit area having a square having a size of 0.5 μm×0.5 μm, one or more of the unit areas that have been divided in which the size of the cross-sectional area of the binder accounts for 50% or more of the unit area are extracted as specific unit areas, and the percentage of the number of specific unit areas that have been extracted with respect to the total number of unit areas is defined to be a percentage of the area occupied by the binder, the percentage of the area occupied by the binder is equal to or larger than 0.2% but equal to or smaller than 3.0%. Accordingly, it becomes possible to increase the filling percentage of the magnetic powder and to maintain a sufficiently high insulation between particles of the magnetic powder. Accordingly, with the method for manufacturing the powder magnetic core according to this embodiment, it is possible to manufacture a powder magnetic core capable of achieving a low loss in a high frequency range while reducing the size thereof.

As described in Background, it is required for inductors to have small sizes and exhibit high inductance characteristics even when a large current is made to flow therethrough. Further, inductors having a low loss in a high frequency range have been required. In order to provide the inductors that satisfy the above conditions, it is required for a powder magnetic core used for an inductor to have a high filling percentage of the magnetic powder and to maintain a sufficiently high insulation between particles of the magnetic powder. However, according to related art, it is difficult to increase the filling percentage of the magnetic powder while maintaining a sufficiently high insulation between particles of the magnetic powder.

On the other hand, in the method for manufacturing the powder magnetic core according to this embodiment, the binder layer is formed using a low melting glass and a resin material. In this manner, by using the low melting glass and the resin material as the binder, even when the amount of binder that is added is small, a thin binder layer (insulating layer) having a uniform thickness can be formed. That is, by using a binder component that is likely to flow easily (low melting glass) and a binder component that is not likely to flow easily (resin material) in a mixed manner at a hot forming temperature, a sufficiently high insulation between particles of the magnetic powder can be maintained even when the amount of binder that is added is made small. That is, according to this embodiment, by intentionally causing the resin material to remain during hot forming, the flow of the low melting glass that is relatively softer than a magnetic powder can be suppressed to some extent. Therefore, a significant portion of the binder that coats the magnetic powder does not flow and remains on the particles of the magnetic powder even after hot forming, which prevents particles of the magnetic powder from contacting each other without using a binder layer (insulating layer).

Further, in the method for manufacturing the powder magnetic core according to this embodiment, the amount of resin material, which is used as a binder, is made small, whereby it is possible to reduce the amount of gas generated in accordance with decomposition of the resin material during hot forming. It is therefore possible to prevent cracks from occurring in a formed body (the powder magnetic core) due to the generated gas.

### <Dimension of Powder Magnetic Core>

Next, the dimension of the powder magnetic core according to this embodiment will be described.

In this embodiment, when the length of the powder magnetic core in the vertical direction (in the example shown in FIG. 1, a distance h) is larger than 4.5 mm, of the distances in the molding die when the powder magnetic core is held by the molding die in the horizontal cross-section of the powder magnetic core, the distance in the molding die in a direction substantially vertical to the direction in which the part inside the powder magnetic core where it takes the longest time for heat to be transferred during the hot forming of the powder magnetic core is extended is set to be equal to or smaller than 4.5 mm. Hereinafter, the dimension of the powder magnetic core will be described with specific examples.

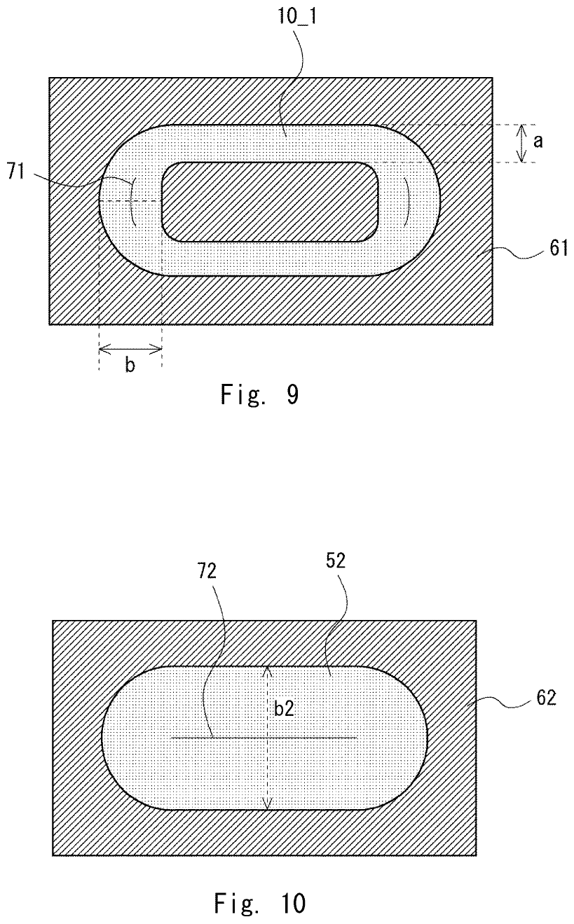

When, for example, the shape of the horizontal cross-section of the powder magnetic core is the one as shown by a powder magnetic core 10_1 in FIG. 9 (the powder magnetic core 10_1 shown in FIG. 9 corresponds to the powder magnetic core 10_1 shown in FIG. 1), the powder magnetic core 10_1 is formed in a state in which it is held by a molding die 61 during hot forming. At this time, heat is transferred from the molding die 61 to the powder magnetic core 10_1, and the part inside the powder magnetic core 10_1 where heat is least likely to be transferred is the part indicated by the reference numeral 71. In this embodiment, a distance b in the molding die in a direction substantially vertical to the direction in which the part 71 inside the powder magnetic core 10_1 where it takes the longest time for heat to be transferred is extended is set to be equal to or smaller than 4.5 mm. By making the powder magnetic core have the aforementioned dimension, heat can be quickly transferred to the whole powder magnetic core 10_1 during hot forming.

Further, when, for example, the shape of the horizontal cross-section of the powder magnetic core is the one as shown in a powder magnetic core 52 shown in FIG. 10 (i.e., a shape with no cavity in the center), the powder magnetic core 52 is formed in a state in which it is held by a molding die 62 during hot forming. At this time, heat is transferred from the molding die 62 to the powder magnetic core 52, and the part inside the powder magnetic core 52 where heat is least likely to be transferred is the part indicated by the reference numeral 72. In this embodiment, a distance b2 in the molding die in a direction substantially vertical to the direction in which the part 72 inside the powder magnetic core 52 where it takes the longest time for heat to be transferred is extended is set to be equal to or smaller than 4.5 mm. By making the powder magnetic core have the aforementioned dimension, heat can be quickly transferred to the whole powder magnetic core 52 during hot forming.

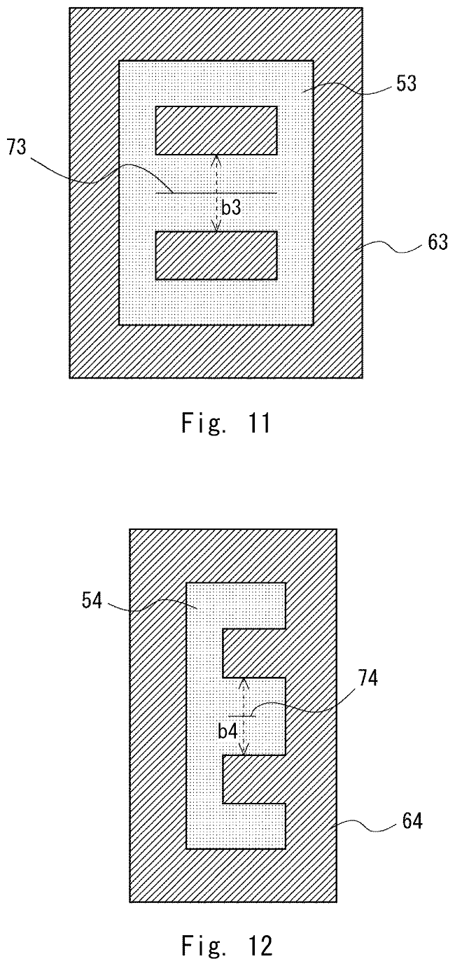

Further, when, for example, the shape of the horizontal cross-section of the powder magnetic core is the one as shown in a powder magnetic core 53 shown in FIG. 11 (i.e., a shape with two cavities in the center), the powder magnetic core 53 is formed in a state in which it is held by a molding die 63 during hot forming. At this time, heat is transferred from the molding die 63 to the powder magnetic core 53, and the part inside the powder magnetic core 53 where heat is least likely to be transferred is the part indicated by the reference numeral 73. In this embodiment, a distance b3 in the molding die in a direction substantially vertical to the direction in which the part 73 inside the powder magnetic core 53 where it takes the longest time for heat to be transferred is extended is set to be equal to or smaller than 4.5 mm. By making the powder magnetic core have the aforementioned dimension, heat can be quickly transferred to the whole powder magnetic core 53 during hot forming.

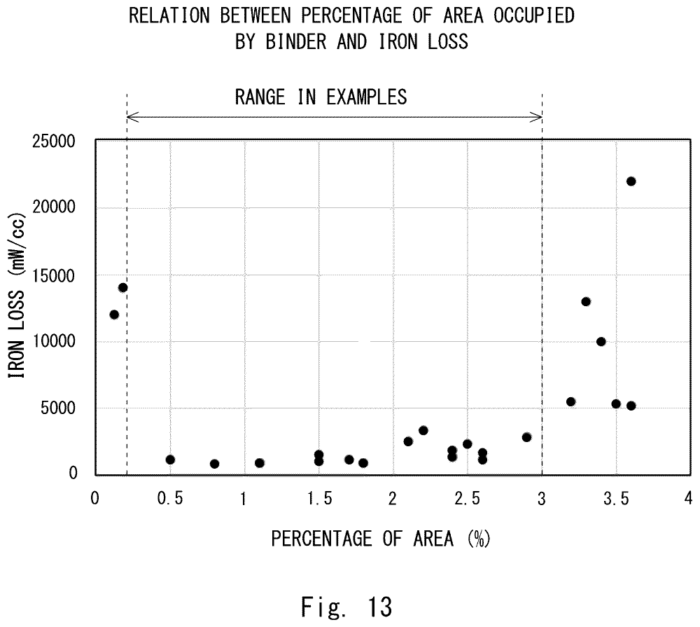

Further, when, for example, the shape of the horizontal cross-section of the powder magnetic core is the one as shown in a powder magnetic core 54 shown in FIG. 12 (i.e., an E-type core), the powder magnetic core 54 is formed in a state in which it is held by a molding die 64 during hot forming. At this time, heat is transferred from the molding die 64 to the powder magnetic core 54, and the part inside the powder magnetic core 54 where heat is least likely to be transferred is the part indicated by the reference numeral 74. In this embodiment, a distance b4 in the molding die in a direction substantially vertical to the direction in which the part 74 inside the powder magnetic core 54 where it takes the longest time for heat to be transferred is extended is set to be equal to or smaller than 4.5 mm. By making the powder magnetic core have the aforementioned dimension, heat can be quickly transferred to the whole powder magnetic core 54 during hot forming.

Note that the configuration examples shown in FIGS. 9-12 are merely examples, and the dimension of the powder magnetic core according to this embodiment can also be applied to powder magnetic cores having other structures. Further, when, for example, the shape of the horizontal cross-section of the powder magnetic core is a circular shape, the part inside the powder magnetic core 54 where it takes the longest time for heat to be transferred is a point. In this case, the diameter of a circle that passes this point is set to be 4.5 mm or smaller. Further, in this embodiment, the length of the powder magnetic core in the vertical direction may be equal to or smaller than 4.5 mm. In this manner, when the length of the powder magnetic core in the vertical direction is set to be equal to or smaller than 4.5 mm, the distance in the molding die in the horizontal cross-section of the powder magnetic core may be set to a desired value.

As described above, by making the powder magnetic core according to this embodiment have the aforementioned dimension, heat can be easily transferred to the powder magnetic core during hot forming. It is therefore possible to reduce the hot forming time and to reduce thermal decomposition of the resin material. Accordingly, the effect of suppressing the flow properties of the low melting glass is enhanced and the iron loss of the powder magnetic core can be reduced.

### EXAMPLE

Next, Examples according to the present disclosure will be described.

### <Experiment 1>

Samples according to Experiment 1 were prepared using the aforementioned method for manufacturing the powder magnetic core (see FIG. 7). The powder magnetic core according to Experiment 1 was formed in a toroidal shape having an outer diameter of 13 mm, an inner diameter of 8 mm, and a length of 5 mm. Specifically, first, a magnetic powder was prepared. An Fe—B—P—Nb—Cr-based powder, which is a metallic glass powder having a particle size of 9 μm (median diameter D50), was used as the magnetic powder. Next, the magnetic powder and a low melting glass powder were mixed, and the magnetic powder was coated with a low melting glass using a mechanochemical method. A phosphate-based glass was used as the low melting glass. At this time, 2.5 volume % of low melting glass was mixed with the magnetic powder.

After that, the magnetic powder coated with the low melting glass was coated with a resin material and was granulated. Each of the resins as shown in Table 1 was used as the resin material. At this time, 2.5 volume % of each resin material was mixed with the magnetic powder. The “loss on heating of the resin at 500° C.” in Table 1 indicates results of a thermogravimetric analysis of the resin (measurement conditions: air atmosphere, heating rate 100° C./min), which shows that the smaller the loss on heating is, the higher the heat resistance of the resin is.

Next, the magnetic powder after granulation was put into a die and pressurized at 500 kgf/cm², and then the pressed powder body was heated and cured at 150° C. without pressurization, thereby preforming the intermediate formed body. After that, the intermediate formed body after being preformed was subject to hot forming in a state in which it is put into a die at 490° C. The hot forming was performed in the air atmosphere, a hot forming temperature of 490° C., a hot forming pressure of 8 tonf/cm², and for a hot forming time of 30 seconds. Further, the heating rate was set to 930° C./min.

Regarding each of the samples prepared as described above, the powder filling percentage of the magnetic core, the magnetic permeability, the iron loss, the percentage of the area occupied by the binder, and the specific resistance were measured.

The powder filling percentage of the magnetic core was obtained by comparing the volume of the magnetic powder included in the magnetic core with the volume of the whole magnetic core measured by an Archimedes method. The volume of the magnetic powder included in the magnetic core is obtained by first obtaining the weight of the magnetic powder included in the magnetic core by subtracting the weight of the low melting glass added as a binder and the weight of the remaining resin material from the weight of the entire magnetic core and then dividing the weight of the magnetic powder by the true density of the magnetic powder.

The magnetic permeability was obtained by preparing a powder magnetic core having a toroidal shape and using an impedance analyzer at a frequency of 1 MHz, and the iron loss was obtained by measuring the prepared powder magnetic core using a B-H analyzer (manufactured by IWATSU ELECTRIC CO., LTD.) by a two-coil method. The measurement was performed under sinusoidal excitation with 1 MHz and 50 mT.

The percentage of the area occupied by the binder was obtained using the aforementioned method. Specifically, a total of four cross-sectional photographs of the powder magnetic core (50 μm×50 μm) (i.e., the photographed area of 10000 μm²) were taken using an SEM. Further, the photographed position was set to be the center of the powder magnetic core. Specifically, since the samples according to Experiment 1 have a toroidal shape, the photographed position was set to be the center of the powder magnetic core on the cut-out surface cut along the central axis of the powder magnetic core.

Next, the area of each of the cross-sectional photographs (50 μm×50 μm) that were taken was divided into unit areas, each unit area having a square having a size of 0.5 μm×0.5 μm. Next, one or more of the unit areas in which the size of the cross-sectional area of the binder accounts for 50% or more of the unit area were extracted as specific unit areas. The percentage of the area of the binder to each unit area was determined using an image analysis software (ImageJ). Next, the percentage of the number of specific unit areas that have been extracted with respect to the total number of unit areas was obtained as the percentage of the area occupied by the binder. Specifically, the percentage of the area occupied by the binder was obtained using the following expression.

Percentage of the area occupied by the binder=(number of specific unit areas that have been extracted/total number of unit areas)×100(%)

The specific resistance was obtained by the following method. First, samples for measuring the specific resistance having a cylindrical shape with a diameter of 13 mm and a height of 1.7 mm were prepared. Next, upper and lower surfaces of the cylinders were ground off, and samples for measurement having a thickness of 1 mm were prepared. Then, conductive paste was applied onto the upper and lower surfaces of the samples for measurement that have been prepared, these samples were held by copper plates, and resistance values were measured. According to this measurement method, the specific resistance inside the powder magnetic core was measured.

Table 1 shows the types of resins used in the respective samples and the results of measurement of each sample. In Comparative Example 1-3, instead of adding a resin, the amount of low melting glass that was added was set to 5 volume %. As shown in Table 1, in Example 1-1 in which a phenol resin was used as a binder resin, Example 1-2 in which a polyimide resin was used as a binder resin, Example 1-3 in which an epoxy resin was used as a binder resin, and Example 1-4 in which an acrylic resin was used as a binder resin, the values of the iron loss became equal to or smaller than 1100, which were good. Further, in each of Examples 1-1 to 1-4, the percentage of the area occupied by the binder was within a range of 0.8 to 1.7%. Further, the specific resistance was within a range of 1×10⁶ to 4×10⁶ (Ωm), which was good.

On the other hand, in each of Comparative Example 1-1 in which a silicone resin was used as a binder resin, Comparative Example 1-2 in which a polyvinyl butyral (PVB) resin was used as a binder resin, and Comparative Example 1-3 in which no resin was used, the value of the iron loss was equal to or larger than 5500, which was large. Further, in each of Comparative Examples 1-1 to 1-3, the percentage of the area occupied by the binder was within a range of 3.2 to 3.6%, which was higher than those in Examples 1-1 to 1-4. Further, the specific resistance in each of Comparative Examples 1-1 to 1-3 was also smaller than those in Examples 1-1 to 1-4.

From the above results, it can be said that a phenol resin, a polyimide resin, an epoxy resin, and an acrylic resin may be preferably used as the resin to be used for the binder layer since they have a great effect in suppressing the flow properties of the low melting glass.

TABLE 1
Experiment 1

| | | Loss on | Powder filling | | Iron loss | | |
|---|---|---|---|---|---|---|---|
| | | heating | percentage of | Magnetic | @1 MHz, | Percentage of | Specific |
| | Type of | of resin at | magnetic core | permeability | 50 mT | area occupied | resistance |
| | resin | 500° C. | (vol. %) | @1 MHz | (kW/m³) | by binder (%) | (Ωm) |
| Example 1-1 | Phenol | 14% | 93.7% | 121 | 900 | 1.1 | 4 × 10⁶ |
| Example 1-2 | Polyimide | 3% | 91.9% | 118 | 780 | 0.8 | 3 × 10⁶ |
| Example 1-3 | Epoxy | 65% | 92.3% | 157 | 970 | 1.5 | 1 × 10⁶ |
| Example 1-4 | Acryl | 73% | 92.8% | 182 | 1,100 | 1.7 | 3 × 10⁶ |
| Comparative | Silicone | 19% | 91.4% | 108 | 10,000 | 3.4 | 6 × 10⁻¹ |
| Example 1-1 | | | | | | | |
| Comparative | PVB | 89% | 93.1% | 188 | 5,500 | 3.2 | 8 × 10⁰ |
| Example 1-2 | | | | | | | |
| Comparative | No resin | — | 92.5% | 168 | 22,000 | 3.6 | 5 × 10⁻² |
| Example 1-3 | | | | | | | |

### <Experiment 2>

In Experiment 2, a powder magnetic core whose particle size of a metallic glass powder (median diameter D50), which is a magnetic powder, is changed was prepared. In Experiment 2, a phosphate-based glass and a phenol resin were used as the materials for the binder. A method similar to that in Experiment 1 was used to prepare the powder magnetic core and measure the samples. In Comparative Example 2-1 and Example 2-1, the volume percentage of the phosphate-based glass with respect to the volume of the magnetic powder was set to 5 volume % and the volume percentage of the phenol resin with respect to the volume of the magnetic powder was set to 2.5 volume %. In Example 2-2, the volume percentage of the phosphate-based glass with respect to the volume of the magnetic powder was set to 2.5 volume % and the volume percentage of the phenol resin with respect to the volume of the magnetic powder was set to 2.5 volume %. Further, as shown in Table 2, since the softening temperature of the phosphate-based glass was 400° C., the glass transition temperature of the magnetic powder was 480° C., and the crystallization temperature of the magnetic powder was 510° C., the forming temperature was set to 490° C.

As shown in Table 2, in Example 2-1 in which the particle size of the metallic glass powder was 7 μm and Example 2-2 in which the particle size of the metallic glass powder was 9 μm, the values of the iron loss were 1100 and 900, respectively, which were good. Further, in Example 2-1, the percentage of the area occupied by the binder was 0.5% and the specific resistance was 7×10⁶ (Ωm), which were good. In Example 2-2, the percentage of the area occupied by the binder was 1.1% and the specific resistance was 4×10⁶ (Ωm), which were good.

On the other hand, in Comparative Example 2-1 in which the particle size of the metallic glass powder was 4 μm, the value of the iron loss was as large as 12000. In Comparative Example 2-1, the percentage of the area occupied by the binder was as small as 0.12% and the specific resistance was as small as 6×10⁻¹ (Ωm). It can be considered that this is because, since the amount of binder that was added was too small in Comparative Example 2-1, the percentage of the area occupied by the binder became low. Further, it can be considered that, since the amount of binder that was added was too small, the binder layer that is present between particles of the magnetic powder was too thin to maintain insulation, which has decreased the specific resistance.

While a phosphate-based glass and a phenol resin were used as materials for a binder in Experiment 2, the present inventors also conducted an experiment in which 5 volume % of phosphate-based glass and 2.5 volume % of polyimide resin with respect to the volume of the magnetic powder were used as a binder. It has been confirmed, in this case, that, even when the particle size of the metallic glass (magnetic powder) was 2 μm, the filling percentage of the powder magnetic core became equal to or higher than 88 volume %, the percentage of the area occupied by the binder was equal to or larger than 0.2% but equal to or smaller than 3.0%. Further, the value of the iron loss was 950, which was good.

TABLE 2
Experiment 2

| | | Particle | | | | Powder | | | Percentage | |
|---|---|---|---|---|---|---|---|---|---|---|
| | | size of | | | | filling | | | of area | |
| | | magnetic | Glass | | | percentage | | Iron loss | occupied | |
| | Type of | powder | transition | Crystallization | Forming | of magnetic | Magnetic | @1 MHz, | by | Specific |
| | magnetic | D50 | temperature | temperature | temperature | core | permeability | 50 mT | binder | resistance |
| | powder | (μm) | (° C.) | (° C.) | (° C.) | (vol. %) | @1 MHz | (kW/m³) | (%) | (Ωm) |
| Comparative | Metallic | 4 | 480 | 510 | 490 | 89.3 | 75 | 12,000 | 0.12 | 6 × 10⁻¹ |
| Example 2-1 | glass | | | | | | | | | |
| Example 2-1 | Metallic | 7 | 480 | 510 | 490 | 90.6 | 103 | 1,100 | 0.5 | 7 × 10⁶ |
| | glass | | | | | | | | | |
| Example 2-2 | Metallic | 9 | 480 | 510 | 490 | 93.7 | 121 | 900 | 1.1 | 4 × 10⁶ |
| | glass | | | | | | | | | |

### <Experiment 3>

In Experiment 3, a powder magnetic core whose particle size of a nanocrystallized powder (median diameter D50), which is an Fe—Si—B—P—Cu—Cr-based magnetic powder, is changed was prepared. In Experiment 3, a phosphate-based glass and a phenol resin were used as the materials for the binder. A method similar to that in Experiment 1 was used to prepare the powder magnetic core and measure the samples. In Experiment 3, the volume percentage of the phosphate-based glass with respect to the volume of the magnetic powder was set to 2.5 volume % and the volume percentage of the phenol resin with respect to the volume of the magnetic powder was set to 2.5 volume %. Further, as shown in Table 3, the forming temperature was set to a temperature between one of the softening temperature of the low melting glass (400° C.) and the first crystallization temperature of the magnetic powder which is higher than the other one and the second crystallization temperature of the magnetic powder.

As shown in Table 3, in Example 3-1 in which the particle size of the nanocrystallized powder was 11 μm, Example 3-2 in which the particle size of the nanocrystallized powder was 14 μm, and Example 3-3 in which the particle size of the nanocrystallized powder was 23 μm, the values of the iron loss were equal to or smaller than 2500, which were good. In Example 3-1 in which the particle size of the nanocrystallized powder was 11 μm, in particular, the value of the iron loss was 860, which was very good. Further, in each of Examples 3-1 to 3-3, the percentage of the area occupied by the binder was within a range of 1.8 to 2.4%. Further, the specific resistance was within a range of 6×10⁵ to 2×10⁶ (Ωm), which was good.

TABLE 3
Experiment 3

| | | Particle | | | | Powder | | | Percentage | |
|---|---|---|---|---|---|---|---|---|---|---|
| | | size of | | | | filling | | | of area | |
| | | magnetic | First | Second | | percentage | | Iron loss | occupied | |
| | Type of | powder | crystallization | crystallization | Forming | of magnetic | Magnetic | @1 MHz, | by | Specific |
| | magnetic | D50 | temperature | temperature | temperature | core | permeability | 50 mT | binder | resistance |
| | powder | (μm) | (° C.) | (° C.) | (° C.) | (vol. %) | @1 MHz | (kW/m³) | (%) | (Ωm) |
| Example | Nanocrystałs | 11 | 420 | 510 | 470 | 92.9 | 115 | 860 | 1.8 | 1 × 10⁶ |
| 3-1 | | | | | | | | | | |
| Example | Nanocrystals | 14 | 400 | 490 | 460 | 92.0 | 118 | 1300 | 2.4 | 6 × 10⁵ |
| 3-2 | | | | | | | | | | |
| Example | Nanocrystals | 23 | 350 | 470 | 440 | 94.3 | 114 | 2500 | 2.1 | 2 × 10⁶ |
| 3-3 | | | | | | | | | | |

### <Experiment 4>

In Experiment 4, a powder magnetic core whose blending ratio of a phosphate-based glass and a phenol resin, both of which being materials for the binder, is changed was prepared. In Experiment 4, a metallic glass powder having a particle size of 9 μm (median diameter D50) was used as the magnetic powder. A method similar to that in Experiment 1 was used to prepare the powder magnetic core and measure the samples. Table 4 shows the blending ratio of the phosphate-based glass and the phenol resin in each of the samples.

As shown in Table 4, in Example 4-1 in which the blending ratio (volume %) of the phosphate-based glass and the phenol resin was 2.5:2.5, the value of the iron loss was 900, which was good. Further, in Example 4-1, the percentage of the area occupied by the binder was 1.1% and the specific resistance was 4×10⁶ (Ωm), which were good. In Example 4-2 in which the blending ratio (volume %) of the phosphate-based glass and the phenol resin was 2.5:5, the value of the iron loss was 1100, which was good. Further, in Example 4-2, the percentage of the area occupied by the binder was 2.6% and the specific resistance was 3×10⁶ (Ωm), which were good.

Further, in Comparative Example 4-1 in which the blending ratio (volume %) of the phosphate-based glass and the phenol resin was 0:2.5 (i.e., no phosphate-based glass is added), the value of the iron loss was 14000, which was large. Further, in Comparative Example 4-1, the percentage of the area occupied by the binder was 0.18% and the specific resistance was 8×10¹ (Ωm), which were small. That is, it can be considered that, in Comparative Example 4-1, a low melting glass, which is a binder, was not added, whereby the resin did not flow and the percentage of the area occupied by the binder became low. However, since the amount of binder itself was small, insulation of particles of the magnetic powder was not secured. It can therefore be considered that the specific resistance has become low.

TABLE 4
Experiment 4

| | | Ratio of | Ratio of | Powder | | | Percentage | |
|---|---|---|---|---|---|---|---|---|
| | | glass | resin | filling | | | of area | |
| | | to | to | percentage | | Iron loss | occupied | |
| | Type of | magnetic | magnetic | of magnetic | Magnetic | @1 MHz, | by | Specific |
| | magnetic | powder | powder | core | permeability | 50 mT | binder | resistance |
| | powder | 100 | 100 | (vol. %) | @1 MHz | (kW/m³) | (%) | (Ωm) |
| Example 4-1 | metallic | 2.5 | 2.5 | 93.3 | 122 | 900 | 1.1 | 4 × 10⁶ |
| | glass | | | | | | | |
| Example 4-2 | metallic | 2.5 | 5 | 89.0 | 84 | 1100 | 2.6 | 3 × 10⁶ |
| | glass | | | | | | | |
| Comparative | metallic | 0 | 2.5 | 94.2 | 148 | 14000 | 0.18 | 8 × 10¹ |
| Example 4-1 | glass | | | | | | | |

### <Experiment 5>

In Experiment 5, samples that have a cylindrical shape having an outer diameter of 40 mm and in which the length thereof in the vertical direction (thickness h) is changed were prepared. In Experiment 5, a nanocrystallized powder having a particle size of 11 μm (median diameter D50) was used as a magnetic powder. Further, a phosphate-based glass and a phenol resin were used as the materials for the binder. The volume percentage of the phosphate-based glass with respect to the volume of the magnetic powder was set to 2.5 volume % and the volume percentage of the phenol resin with respect to the volume of the magnetic powder was set to 2.5 volume %. A method similar to that in Experiment 1 was used to prepare the powder magnetic core. Further, in Experiment 5, the forming temperature was set to 470° C. Further, in Experiment 5, the prepared powder magnetic core was cut into a shape that is similar to that in Experiment 1 (a toroidal shape having an outer diameter of 13 mm, an inner diameter of 8 mm, and a length of 5 mm) and the samples for measurement were prepared. Then the samples were measured using a method similar to that in Experiment 1.

As shown in Table 5, the forming time of each of the samples was changed depending on the thickness of the smallest part. That is, the forming time of the samples was made larger as the thickness h increases so that heat is transferred to the part inside the powder magnetic core where it takes the longest time for the heat to be transferred and the heat is transferred to the entire powder magnetic core. More specifically, the forming time was set so that heat is transferred to the intermediate part of the length of the powder magnetic core in the vertical direction (thickness h) and a sufficient amount of deformation due to softening of the magnetic powder in the entire powder magnetic core is obtained.

As shown in Table 5, in Example 5-1 in which the thickness h was 1.7 mm, Example 5-2 in which the thickness h was 2.5 mm, Example 5-3 in which the thickness h was 3.0 mm, Example 5-4 in which the thickness h was 3.5 mm, and Example 5-5 in which the thickness h was 4.5 mm, the values of the iron loss were equal to or smaller than 2800. In particular, in Example 5-1 in which the thickness h was 1.7 mm, the value of the iron loss was 860, which was very good. Further, in each of Examples 5-1 to 5-5, the percentage of the area occupied by the binder was within a range of 1.5 to 2.9%. Further, in each of Examples 5-1 to 5-5, the specific resistance was within a range of 6×10⁴ to 4×10⁶ (Ωm), which was good.

On the other hand, in Comparative Example 5-1 in which the thickness h was 7 mm and Comparative Example 5-2 in which the thickness h was 14 mm, the values of the iron loss became larger than 3300. Further, in Comparative Example 5-1, the percentage of the area occupied by the binder was 3.6% and the specific resistance was 7×10⁻¹. In Comparative Example 5-2, the percentage of the area occupied by the binder was 3.3% and the specific resistance was 2×10⁻². In this manner, it can be considered that, in each of Comparative Examples 5-1 and 5-2, the percentage of the area occupied by the binder was large, specific resistance became low.

From the above results, it can be said that the length of the powder magnetic core in the vertical direction (thickness h), which is the part inside the powder magnetic core where it takes the longest time for heat to be transferred during the hot forming of the powder magnetic core, is preferably equal to or smaller than 4.5 mm. That is, heat is rapidly transferred to the entire powder magnetic core during hot forming, whereby thermal decomposition of the binder resin can be suppressed and the reduction in the effect of suppressing the flow properties of the low melting glass can be prevented, and good values of the iron loss can be obtained. Further, since heat is rapidly transferred to the entire powder magnetic core, the time of the hot forming can be shortened, resulting in reduced production time and cost. While Experiment 5 has been conducted while changing the length of the powder magnetic core in the vertical direction, setting the distance in the molding die in the direction substantially vertical to the direction in which the part inside the powder magnetic core where it takes the longest time for heat to be transferred is extended to be equal to or smaller than 4.5 mm is also preferable due to a reason similar to that stated above.

TABLE 5
Experiment 5

| | | | | Powder | | | Percentage | |
|---|---|---|---|---|---|---|---|---|
| | Thickness | | | filling | | | of area | |
| | h of | | Heating | percentage | | Iron loss | occupied | |
| | powder | | rate | of magnetic | Magnetic | @1 MHz, | by | Specific |
| | magnetic | Forming | (° C./ | core | permeability | 50 mT | binder | resistance |
| | (mm) | time | min) | (vol. %) | @1 MHz | (kW/m³) | (%) | (Ωm) |
| Example 5-1 | 1.7 | 10 seconds | 2670 | 92.9 | 115 | 860 | 1.8 | 1 × 10⁶ |
| Example 5-2 | 2.5 | 30 seconds | 890 | 93.1 | 120 | 1,500 | 1.5 | 4 × 10⁶ |
| Example 5-3 | 3 | 45 seconds | 590 | 92.8 | 123 | 1,800 | 2.4 | 8 × 10⁵ |
| Example 5-4 | 3.5 | 1 minute | 450 | 92.5 | 118 | 2,300 | 2.5 | 6 × 10⁴ |
| Example 5-5 | 4.5 | 1.5 minutes | 300 | 91.7 | 103 | 2,800 | 2.9 | 3 × 10⁵ |
| Comparative | 7 | 4 minutes | 110 | 92.2 | 113 | 5,200 | 3.6 | 7 × 10⁻¹ |
| Example 5-1 | | | | | | | | |
| Comparative | 14 | 15 minutes | 30 | 91.1 | 107 | 13,000 | 3.3 | 2 × 10⁻² |
| Example 5-2 | | | | | | | | |

### <Experiment 6>

In Experiment 6, samples whose type of the low melting glass, which is a material for the binder, is changed were prepared. In Experiment 6, a metallic glass powder having a particle size of 9 μm (median diameter D50), a glass transition temperature (Tg) of 480° C., and a crystallization temperature (Tx) of 510° C. was used as a magnetic powder. A phenol resin was used as a binder resin. The volume percentage of each low melting glass with respect to the magnetic powder was set to 2.5% volume % and the volume percentage of the phenol resin with respect to the volume of the magnetic powder was set to 2.5 volume %. A method similar to that in Experiment 1 was used to prepare the powder magnetic core and measure the samples.

As shown in Table 6, in Example 6-1 in which a phosphate-based glass was used as the low melting glass, Example 6-2 in which a tin phosphate-based glass was used as the low melting glass, and Example 6-3 in which a bismuth oxide-based glass was used as the low melting glass, the values of the iron loss were 900, 1600, and 3300, respectively. Further, the percentage of the area occupied by the binder in Example 6-1 was 1.1%, the percentage of the area occupied by the binder in Example 6-2 was 2.6%, and the percentage of the area occupied by the binder in Example 6-3 was 2.2%, respectively. Further, the specific resistance in Example 6-1 was 4×10⁶ (Ωm), the specific resistance in Example 6-2 was 1×10⁶ (Ωm), and the specific resistance in Example 6-3 was 5×10⁵ (Ωm).

On the other hand, in Comparative Example 6-1 in which a boro-silicate-based glass was used as a low melting glass, the value of the iron loss was as large as 5300. In Comparative Example 6-1, the percentage of the area occupied by the binder was 3.5% and the specific resistance was 3×10¹. That is, it can be considered that, since the softening temperature of the low melting glass is higher than the forming temperature in Comparative Example 6-1, the low melting glass is not sufficiently softened during hot forming, and the binder was not deformed in association with the deformation of the powder. Therefore, the percentage of the area occupied by the binder became large and the specific resistance became low.

TABLE 6
Experiment 6

| | | | Powder | | | Percentage | |
|---|---|---|---|---|---|---|---|
| | | | filling | | | of area | |
| | | Softening | percentage | | Iron loss | occupied | |
| | | temperature | of magnetic | Magnetic | @1 MHz, | by | Specific |
| | Glass | of glass | core | permeability | 50 mT | binder | resistance |
| | composition | (° C.) | (vol. %) | @1 MHz | (kW/m³) | (%) | (Ωm) |
| Example 6-1 | Phosphate- | 400 | 93.7% | 121 | 900 | 1.1 | 4 × 10⁶ |
| | based | | | | | | |
| Example 6-2 | Tin phosphate- | 350 | 93.6% | 112 | 1,600 | 2.6 | 1 × 10⁶ |
| | based | | | | | | |
| Example 6-3 | Bismuth oxide- | 410 | 92.6% | 117 | 3,300 | 2.2 | 5 × 10⁵ |
| | based | | | | | | |
| Comparative | Boro-silicate- | 520 | 91.6% | 132 | 5,300 | 3.5 | 3 × 10¹ |
| Example 6-1 | based | | | | | | |

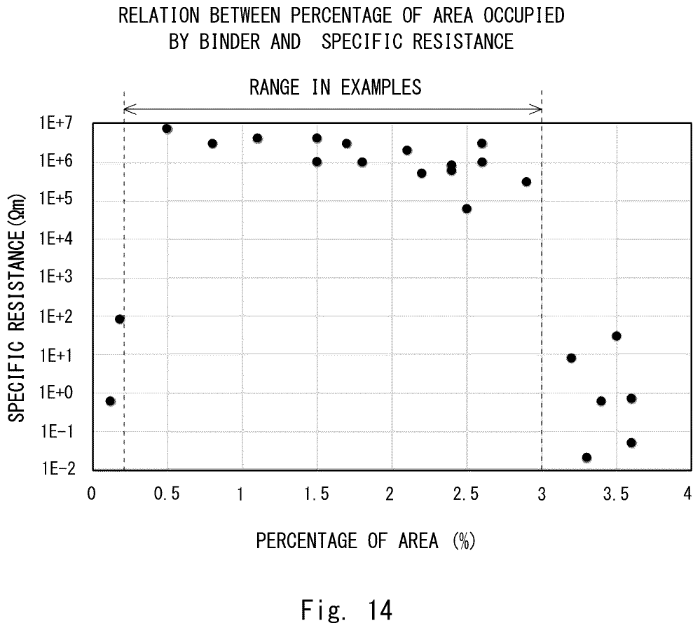

FIG. 13, which is a graph showing a relation between the percentage of the area occupied by the binder and the iron loss, is a graph in which the results of the above Experiments 1 to 6 are plotted. As shown in the graph of FIG. 13, the percentage of the area occupied by the binder in Examples was within a range of 0.2% or larger but 3.0% or smaller. In this range, the iron loss of the powder magnetic core at 1 MHz and 50 mT becomes 3300 kW/m³ or smaller. Further, in a range in which the percentage of the area occupied by the binder was 0.2% or larger but 2.1% or smaller, the iron loss of the powder magnetic core at 1 MHz and 50 mT becomes 2500 kW/m³ or smaller. Further, in a range in which the percentage of the area occupied by the binder was 0.2% or larger but 1.8% or smaller, the iron loss of the powder magnetic core at 1 MHz and 50 mT becomes 1500 kW/m³ or smaller.

FIG. 14, which is a graph showing a relation between the percentage of the area occupied by the binder and the specific resistance, is a graph in which the results of the above Experiments 1 to 6 are plotted. As shown in the graph of FIG. 14, the percentage of the area occupied by the binder in Examples was 0.2% or larger but 3.0% or smaller. In this range, the specific resistance of the powder magnetic core is 5×10⁴ (Ωm) or larger. Further, in a range in which the percentage of the area occupied by the binder was 0.2% or larger but 2.4% or smaller, the specific resistance of the powder magnetic core is equal to or larger than 1×10⁵ (Ωm). Further, in a range in which the percentage of the area occupied by the binder was 0.2% or larger but 2.1% or smaller, the specific resistance of the powder magnetic core is equal to or larger than 1×10⁶ (Ωm).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A powder magnetic core in which a magnetic powder is bonded via a binder layer, wherein
the powder magnetic core contains 88 volume % or more of magnetic powder, and
when a cross-sectional photograph of the powder magnetic core is taken using a scanning electron microscope, an area of the cross-sectional photograph having a size of 10000 μm² is divided into unit areas, each unit area having a square having a size of 0.5 μm×0.5 μm, one or more of the unit areas in which the size of a cross-sectional area of a binder accounts for 50% or more of the unit area are extracted as specific unit areas, and the percentage of the number of specific unit areas that have been extracted with respect to the total number of unit areas is defined to be a percentage of the area occupied by the binder, the percentage of the area occupied by the binder is equal to or larger than 0.2% but equal to or smaller than 3.0%.

2. The powder magnetic core according to claim 1, wherein the percentage of the area occupied by the binder is equal to or larger than 0.2% but equal to or smaller than 2.6%.

3. The powder magnetic core according to claim 1, wherein
the magnetic powder is a soft magnetic powder that contains an iron element, and
the particle size of the magnetic powder is equal to or larger than 2 μm but equal to or smaller than 25 μm.

4. The powder magnetic core according to claim 3, wherein the magnetic powder is a metallic glass or a nanocrystallized powder.

5. The powder magnetic core according to claim 1, wherein the binder layer comprises a low melting glass and a resin material.

6. The powder magnetic core according to claim 5, wherein the total amount of the low melting glass and the resin material with respect to the amount of the magnetic powder is smaller than 10 volume %.

7. The powder magnetic core according to claim 6, wherein the volume percentage of the low melting glass with respect to the volume of the magnetic powder is equal to or larger than 0.5 volume % but equal to or smaller than 6 volume %.

8. The powder magnetic core according to claim 6, wherein the volume percentage of the resin material with respect to the volume of the magnetic powder is equal to or larger than 0.5 volume % but equal to or smaller than 9 volume %.

9. The powder magnetic core according to claim 5, wherein the low melting glass is a phosphate-based or a tin phosphate-based glass.

10. The powder magnetic core according to claim 5, wherein the resin material is at least one type of resin material selected from the group consisting of a phenol resin, a polyimide resin, an epoxy resin, and an acrylic resin.

11. The powder magnetic core according to claim 1, wherein the iron loss of the powder magnetic core at 1 MHz and 50 mT is equal to or smaller than 3300 kW/m³.

12. The powder magnetic core according to claim 1, wherein the specific resistance of the powder magnetic core is equal to or larger than 5×10⁴ (Ωm).

13. An inductor comprising the powder magnetic core according to claim 1 and a coil.

14. A method for manufacturing a powder magnetic core, the method comprising:
a process of coating a magnetic powder with a low melting glass;
a process of coating the magnetic powder coated with the low melting glass with a resin material for granulation; and
a process of hot forming the magnetic powder after the granulation, wherein
the powder magnetic core after the hot forming contains 88 volume % or more of magnetic powder, and
when a cross-sectional photograph of the powder magnetic core is taken using a scanning electron microscope, an area of the cross-sectional photograph having a size of 10000 μm² is divided into unit areas, each unit area having a square having a size of 0.5 μm×0.5 μm, one or more of the unit areas in which the size of a cross-sectional area of a binder accounts for 50% or more of the unit area are extracted as specific unit areas, and the percentage of the number of specific unit areas that have been extracted with respect to the total number of unit areas is defined to be a percentage of the area occupied by the binder, the percentage of the area occupied by the binder is equal to or larger than 0.2% but equal to or smaller than 3.0%.

15. The method for manufacturing the powder magnetic core according to claim 14, wherein
the magnetic powder is a soft magnetic powder that contains an iron element, and
a particle size of the magnetic powder is equal to or larger than 2 μm but equal to or smaller than 25 μm.

16. The method for manufacturing the powder magnetic core according to claim 14, wherein
the magnetic powder is a metallic glass, and
the temperature when the magnetic powder is subject to hot forming is equal to or higher than one of the softening temperature of the low melting glass and a glass transition temperature of the magnetic powder which is higher than the other one but is equal to or lower than a crystallization temperature of the magnetic powder.

17. The method for manufacturing the powder magnetic core according to claim 14, wherein
the magnetic powder is a nanocrystallized powder, and
the temperature when the magnetic powder is subject to hot forming is equal to or higher than one of the softening temperature of the low melting glass and the first crystallization temperature of the magnetic powder which is higher than the other one but is equal to or lower than the second crystallization temperature of the magnetic powder.

18. The method for manufacturing the powder magnetic core according to claim 14, wherein the total amount of the low melting glass and the resin material with respect to the amount of the magnetic powder is smaller than 10 volume %.

19. The method for manufacturing the powder magnetic core according to claim 14, wherein the low melting glass is a phosphate-based or a tin phosphate-based glass.

20. The method for manufacturing the powder magnetic core according to claim 14, wherein the resin material is at least one type of resin material selected from the group consisting of a phenol resin, a polyimide resin, an epoxy resin, and an acrylic resin.
